(19) United States
(12) Patent Application Publication
(10) Pub. No.: US 2026/0053713 A1
(43) Pub. Date: Feb. 26, 2026

(54) SMART PILLBOX

(71) Applicant: HELLO HEART INC., MENLO PARK, CA (US)

(72) Inventors: MICHAL GUTMAN, TEL AVIV (IL); GIORA FELDMAN, KFAR VRADIM (IL); SHIR HECHTER, TEL AVIV (IL)

(73) Assignee: HELLO HEART INC., MENLO PARK, CA (US)

(21) Appl. No.: 19/310,499

(22) Filed: Aug. 26, 2025

Related U.S. Application Data
(60) Provisional application No. 63/687,052, filed on Aug. 26, 2024.

(51) Int. Cl. A61J 7/04; A61J 1/03; A61J 7/00

(52) U.S. Cl. CPC A61J 7/0481; A61J 1/03; A61J 7/0069

(57) ABSTRACT

A medication container is provided that includes a pillbox designed to hold a user's solid medications. The term “pill,” as used herein, refers to any “solid medication,” encompassing tablets, capsules, powders, herbs, edibles, dietary supplements, suppositories, and similar forms. The pillbox can include a main body, a lid, cells for containing pills, and a circuit system. The pillbox may be organized into, for example, individual cells for each day of the week, or individual cells for time of the day (for example, morning, afternoon and evening). A cell may be organized into individual compartments for time of the day (for example, day and night). The circuit systems may be configured to include sensors (for example, sensors that correspond to a cell, or the lid) and lights.

### RELATED APPLICATIONS

This application claims the benefit, and priority benefit, of U.S. Provisional Patent Application Ser. No. 63/687,052, filed Aug. 26, 2024, the disclosure and contents of which are incorporated by reference herein in their entirety.

### BACKGROUND

### 1. Field of the Invention

The presently disclosed subject matter relates generally to pillboxes for storing medications, and more specifically, to a system for tracking and guiding a person's medication usage using a smart pillbox.

### 2. Description of the Related Art

Patient adherence to medication is a critical challenge in managing chronic diseases like hypertension. Despite the availability of effective treatments, many patients struggle to consistently take their prescribed medications as directed.

Factors contributing to poor adherence include forgetfulness, complex dosing schedules, medication side effects, and a lack of understanding about the importance of consistent treatment. Non-adherence can lead to uncontrolled blood pressure, increased risk of complications such as heart attack or stroke, and higher healthcare costs.

Improvements in this field of technology are therefore desired.

### SUMMARY

Various illustrative embodiments of a system for tracking and guiding a person's medication usage using a smart pillbox are described herein.

In certain illustrative embodiments, a pillbox is provided. The pillbox can include: a main body including a tray; a plurality of cells receivable in the tray of the main body, each cell configured to hold medication; a lid movably coupled to the main body and configured to open and close the pillbox; a sensor system comprising a lid sensor and a plurality of cell sensors, the lid sensor configured to sense opening and closing of the pillbox, wherein the plurality of cell sensors are configured to sense a state associated with each of the plurality of cells; and circuitry operatively coupled to the sensor system and configured to take an action in response to one or more signals received from the lid sensor, the cell sensors, or both the lid and cell sensors, wherein the action comprises a reward animation sequence that sequentially illuminates light emitters associated with the plurality of cells after detecting that a user has complied with a prescription schedule for a predetermined period for medication held in the pillbox.

In certain aspects, the prescription schedule can include the user taking all of the medication held in the plurality of cells. The predetermined period can comprise a full seven-day schedule. The reward animation sequence can include the light emitters lighting up sequentially for each cell in the tray from a first end of the pillbox to a second end of the pillbox. The light emitters can light up one cell at a time. Each of the plurality of cells can contain a permanent magnet, and each of the plurality of cell sensors can include a Hall-effect sensor, and within each of the plurality of cells, the Hall effect sensor can be configured to sense a magnetic field associated with the permanent magnet and sense opening or closing of the pillbox. The pillbox can further include a plurality of Hall-effect sensors positioned beneath the tray, wherein each Hall-effect sensor can be configured to sense insertion or removal of a corresponding cell from the plurality of cells. The pillbox can further include a rechargeable lithium-ion battery sized to power the pillbox for at least thirty days of operation at a duty cycle of one Wi-Fi synchronization per day. The pillbox can further include an indication system operatively coupled to the circuitry, the indicating system including: an LED beacon configured to provide a visual indication of a state associated with the pillbox; and a plurality of LED indicators, each LED indicator associated with a cell of the plurality of cells. The LED indicators can include addressable RGB LEDs.

In certain illustrative embodiments, a pillbox is provided that can include: a main body including a tray; a plurality of cells receivable in the tray of the main body, each cell configured to hold medication; a lid movably coupled to the main body and configured to open and close the pillbox; a sensor system; and circuitry operatively coupled to the sensor system. The sensor system can include a lid sensor and plurality of cell sensors, whereby the lid sensor can be configured to sense opening and closing of the pillbox, and the cell sensors can be configured to sense a state associated with each of the plural cells. The circuitry can be configured to take an action in response to one or more signals received from the lid sensor, the cell sensors, or both the lid and cell sensors.

In certain aspects, the pillbox can further include an indication system operatively coupled to the circuitry. The indication system can include an LED beacon configured to provide a visual indication of a state associated with the pillbox. The indication system can include a plurality of LED indicators, each LED indicator associated with a cell of the plural cells. The pillbox can include a communication system operatively coupled to the circuitry and configured to provide wireless communication with a user device.

In certain illustrative embodiments, a system for monitoring a user's adherence to a medication schedule is provided. The system can include a pillbox which includes: a main body including a tray, a plurality of cells receivable in the tray of the main body, each cell configured to hold medication, a lid movably coupled to the main body and configured to open and close the pillbox, a sensor system including a lid sensor and a plurality of cell sensors, the lid sensor configured to sense opening and closing of the pillbox and the plurality of cell sensors configured to sense a state associated with each of the plurality of cells, and circuitry operatively coupled to the sensor system and configured to take an action in response to one or more signals received from the lid sensor, the cell sensors, or both the lid and cell sensors. The system can also include a user device comprising a processor and a display, wherein the processor is configured to communicate with the pillbox and display information about the pillbox via the display.

In certain aspects, the processor can be configured to display, via the display, information indicative of medication use by the user and information indicative of one or more health outcomes associated with the user, wherein the one or more health outcomes can include an upward or downward trend in average blood pressure. The system can be operatively coupled to a blood pressure measurement device and configured to receive communication from the blood pressure measurement device regarding blood pressure data of the user, and the blood pressure data can be used to determine the upward or downward trend in average blood pressure. The processor can be configured to determine medication use by the user based on information communicated with the pillbox, thereby monitoring the user's adherence to a medication schedule. The processor can be configured to determine the user's adherence to the medication schedule and display information about the adherence to the medication schedule via the display. The adherence to a medication schedule can include a consecutive streak of days where the medication was taken. The adherence to a medication schedule can also include a percentage of days where the medication was taken over a single time period. The adherence to a medication schedule can also include a comparison between the number of pills taken between at least two different time periods.

In addition, the circuitry can include a Bluetooth low energy transceiver and a wi-fi transceiver, and the circuity can be configured to communicate adherence data to the user device via the Bluetooth low energy transceiver when the user device is within a predefined range. The circuitry can also be configured to communicate adherence data to a remote cloud server via the wi-fi transceiver when the user device is outside the predefined range for at least ten minutes. The circuitry can also be configured to calculate an adherence metric locally when no network connection is available and to synchronize the metric with the remote server upon re-establishing either Bluetooth low energy or wi-fi connectivity.

In certain illustrative embodiments, a system for monitoring a user's adherence to a medication schedule is provided. The system can include: a pillbox according to the present disclosure; and a user device including a processor and a display, wherein the processor is configured to communicate with the pillbox and display information about the pillbox via the display.

In certain illustrative embodiments, a computer-implemented method is provided. The method can include receiving, for each of a plurality of users, blood pressure measurements comprising timestamps and systolic values; receiving medication adherence signals comprising daily indicators of tracked compliance and consumed compliance; binning the blood pressure measurements and the medication adherence signals by a common temporal interval to form per-user binned sequences; joining, per user, the binned blood pressure sequence with the binned adherence sequence by temporal interval to create joint sequences having non-null pairs and nulls otherwise; filtering the joint sequences to retain users having at least three non-null pairs, a blood-pressure range of at least two units, and an average tracked compliance exceeding 0.3; computing, for each retained user, a Pearson correlation coefficient between the binned blood pressure sequence and the binned consumed compliance sequence; labeling a correlation as significant when an absolute value of the coefficient is at least 0.3; and classifying a trend using last two non-null binned values of each sequence to produce one of: positive-correlation BP-up/medication-up. positive-correlation BP-down/medication-down, negative-correlation BP-up/medication-down, negative-correlation BP-down/medication-up, or a no-correlation class stratified by last blood-pressure bin and last adherence bin. In certain aspects, the temporal interval is one week and the consumed compliance for a week is an average over daily medication-consumption indicators across all medications. The method can further comprise assigning an insight validity period of seven days from creation and a time-to-live of ninety days. The blood pressure measurements can comprise diastolic values and the method is performed for systolic, diastolic, or both.

In certain illustrative embodiments, a computer-implemented method is provided. The method can include: identifying a medication-add event for a user from medication records created between one and four months before an analysis time; selecting the user's blood pressure measurements in a window spanning at least five months and tagging each measurement as before or after the medication-add event when within one month of the event; computing a before-window median and an after-window median of blood pressure; determining an effect size by requiring: an absolute difference between the medians of at least 5 mmHg, and at least one of a maximum-before to minimum-after difference or a minimum-before to maximum-after difference of at least 10 mmHg; and upon satisfying the effect-size requirements, emitting a result comprising the direction of change determined by comparing a most-recent blood pressure to the before-window median. The method can further comprise aggregating results across users to compute a count of users with reduced blood pressure after the medication-add event, a mean of per-user median differences, and a percentage relative to all evaluated users. The tagging window is configurable and defaults to plus or minus one month. The method can further comprise aggregating per-user results into a population-level insight that includes at least one of a fraction of users satisfying a significance or effect-size criterion, and an average effect magnitude.

In certain illustrative embodiments, a system is provided that comprises one or more processors and memory storing instructions which, when executed, cause the system to perform any of the aforementioned methods, and further to generate user interface cards that encode correlation class and trend based on the last two binned points.

In certain illustrative embodiments, a non-transitory computer-readable medium is provided that stores instructions that, when executed by one or more processors, cause the processors to perform any of the aforementioned methods.

### BRIEF DESCRIPTION OF THE DRAWINGS

A better understanding of the presently disclosed subject matter can be obtained when the following detailed description is considered in conjunction with the following drawings, in which like reference characters refer to the same parts throughout the different views, and wherein the drawings are not necessarily to scale, emphasis instead being placed upon illustrating embodiments, and wherein:

FIG. 1 is a top perspective view of a pillbox in accordance with an illustrative embodiment of the presently disclosed subject matter;

FIGS. 2A-2E are schematic diagrams illustrating user interface screens of a mobile device in accordance with illustrative embodiments of the presently disclosed subject matter;

FIG. 3 is a side perspective view of a cell for a pillbox in accordance with an illustrative embodiment of the presently disclosed subject matter;

FIG. 4 is a exploded side perspective view of a cell for a pillbox, in accordance with an illustrative embodiment of the presently disclosed subject matter;

FIG. 5 is a side view of a cell for a pillbox, in accordance with an illustrative embodiment of the presently disclosed subject matter;

FIG. 6 is a side perspective view of a cell for a pillbox, in accordance with an illustrative embodiment of the presently disclosed subject matter;

FIG. 7 is a side perspective view of a pillbox with the lid opened in accordance with an illustrative embodiment of the presently disclosed subject matter; and

FIG. 8 is a front view of a pillbox with the lid opened in accordance with an illustrative embodiment of the presently disclosed subject matter.

FIG. 9 is a zoomed-in segment of magnets and related features in accordance with an illustrative embodiment of the presently disclosed subject matter.

FIG. 10 is a zoomed-in segment of features from FIG. 8 in accordance with an illustrative embodiment of the presently disclosed subject matter.

FIG. 11 is a graph displaying size and grade information for cell magnets in accordance with an illustrative embodiment of the presently disclosed subject matter.

FIG. 12 is an image displaying specification and other information for cell magnets in accordance with an illustrative embodiment of the presently disclosed subject matter.

FIG. 13 is a zoomed-in segment of features from FIG. 14 in accordance with an illustrative embodiment of the presently disclosed subject matter.

FIG. 14 is a front view of cell magnets for a pillbox in accordance with an illustrative embodiment of the presently disclosed subject matter.

FIG. 15 is a front view of a printed circuit board assembly in accordance with an illustrative embodiment of the presently disclosed subject matter.

FIG. 16 is a rear view of a printed circuit board assembly in accordance with an illustrative embodiment of the presently disclosed subject matter.

FIG. 17 is a front view of a pillbox with the lid closed and no lighting indication in accordance with an illustrative embodiment of the presently disclosed subject matter.

FIG. 18 is a front view of a pillbox with the lid closed and a lighting indication that it is time to take a pill in accordance with an illustrative embodiment of the presently disclosed subject matter.

FIG. 19 is a front view of a pillbox with the lid closed and a lighting indication that it is time to refill the pillbox in accordance with an illustrative embodiment of the presently disclosed subject matter.

FIG. 20 is a front view of a pillbox with the lid opened and a lighting indication that it is time to take a pill on a Saturday in accordance with an illustrative embodiment of the presently disclosed subject matter.

FIG. 21 is a front view of a pillbox with the lid opened and a lighting indication of an investment that the user took pills for the first three days of the week in accordance with an illustrative embodiment of the presently disclosed subject matter.

FIG. 22 is a front view of a pillbox with the lid opened and a lighting indication of an end of week piano reward (early indication) in accordance with an illustrative embodiment of the presently disclosed subject matter.

FIG. 23 is a front view of a pillbox with the lid opened and a lighting indication of a start state that the cup is out of the pillbox in accordance with an illustrative embodiment of the presently disclosed subject matter.

FIG. 24 is a front view of a pillbox with the lid opened and a lighting indication of an alert state (after 30 seconds) that the cup is out of the pillbox in accordance with an illustrative embodiment of the presently disclosed subject matter.

FIG. 25 is a block diagram of a system architecture for ingesting BP and medication records and producing insights in accordance with an illustrative embodiment of the presently disclosed subject matter.

FIG. 26 illustrates per-user timeline construction and weekly binning in accordance with an illustrative embodiment of the presently disclosed subject matter.

FIG. 27 is a flowchart of the Pearson correlation pipeline with significance gating and trend labeling in accordance with an illustrative embodiment of the presently disclosed subject matter.

FIG. 28 is a flowchart of the before/after pipeline around medication-add events in accordance with an illustrative embodiment of the presently disclosed subject matter.

FIG. 29 depicts card-type classification logic for positive, negative, and no-correlation cases in accordance with an illustrative embodiment of the presently disclosed subject matter.

FIG. 30 illustrates population-level aggregation (“sneak peek”) and lifecycle management in accordance with an illustrative embodiment of the presently disclosed subject matter.

FIG. 31 illustrates an example output (negative correlation; BP down, medication up) for a Pearson correlation pipeline (BP vs medication adherence) in accordance with an illustrative embodiment of the presently disclosed subject matter.

FIG. 32 illustrates an example output (sneak peek) for a Before/After pipeline (BP vs medication-add events) in accordance with an illustrative embodiment of the presently disclosed subject matter.

While certain preferred illustrative embodiments can be described herein, it can be understood that this description is not intended to limit the subject matter to those embodiments. On the contrary, it is intended to cover all alternatives, modifications, and equivalents, as may be included within the spirit and scope of the subject matter as defined by the appended claims.

### DETAILED DESCRIPTION

The presently disclosed subject matter relates generally to pillboxes for storing medications, and more specifically, to a system for tracking and guiding a person's medication usage using a smart pillbox.

The subject matter is described more fully hereinafter with reference to the accompanying drawings in which embodiments of the pillbox and system are shown. The pillbox and system may, however, be embodied in many different forms and should not be construed as limited to the embodiments set forth herein; rather, these embodiments are provided so that this disclosure can be thorough and complete, and can fully convey the scope of the pillbox and system to those skilled in the art.

Adherence to prescribed medication is crucial, especially for individuals managing chronic conditions. Many medications, particularly those in pill form, are self-administered with little to no supervision. This self-administration raises the risk of non-compliance, as persons (such as, e.g., healthcare patients) may not follow instructions regarding dosage and timing accurately. Studies estimate that less than 50% of prescriptions are taken as directed, which can significantly reduce the effectiveness of treatments and increase the potential for harm to patients. Non-compliance not only undermines the therapeutic benefits but also escalates healthcare costs and strains resources, which could be better utilized elsewhere.

Non-compliance often stems from simple mistakes or neglect, particularly with complex medication regimens under chronic conditions. It is beneficial for healthcare professionals to be aware of any deviations from prescribed usage to take corrective action or adjust treatment plans. During medical appointments, patients may struggle to accurately recall and relay information about their medication use and symptoms due to memory lapses. This can lead to underdosing, overdosing, medication abuse, and dependency, all of which negatively impact overall health and can be life-threatening. The overuse of certain medications is a significant societal issue. To address these challenges, healthcare professionals (as well as patients) need effective tools to determine medication adherence, detect abuse patterns, prevent misuse, limit diversion, and enhance education for those at risk.

Systems and methods are provided herein for tracking and guiding a patient's clinically directed medication usage. The disclosed innovative solutions aim to address the above challenges by providing reminders, tracking adherence, and offering personalized feedback to patients and healthcare providers. These technologies have the potential to significantly improve medication adherence rates, enhance patient outcomes, and reduce the burden of chronic disease management.

### Pillbox

In certain illustrative embodiments, a medication container is provided that includes a pillbox 100 designed to hold a user's solid medications. The term “pill,” as used herein, refers to any “solid medication,” encompassing tablets, capsules, powders, herbs, edibles, dietary supplements, suppositories, and similar forms.

In certain illustrative embodiments, the pillbox 100 comprises a main body, a lid 110, cells 140 for containing pills, and a circuit system 130. The pillbox 100 may be organized into, for example, individual cells 140 for each day of the week (e.g., “S” or “Sun” for Sunday, “M” for Monday, “T” for Tuesday, “W” for Wednesday, “T” or “Th” for Thursday, “F” for Friday and “S” or “Sat” for Saturday), or individual cells 140 for time of the day (for example, morning, afternoon and evening). In certain illustrative embodiments, a cell 140 may be organized into individual compartments for time of the day (for example, day and night). The circuit system 130 may be configured to include sensors (for example, sensors that correspond to a cell 140, or the lid 110) and lights.

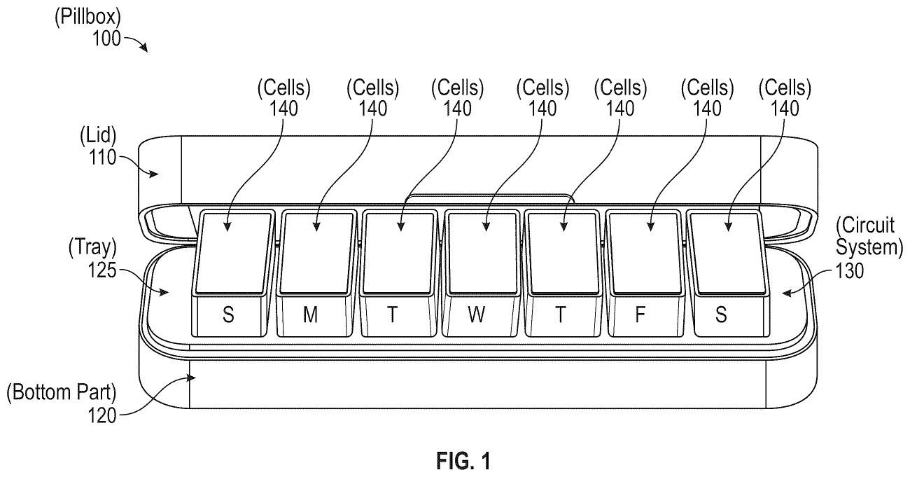

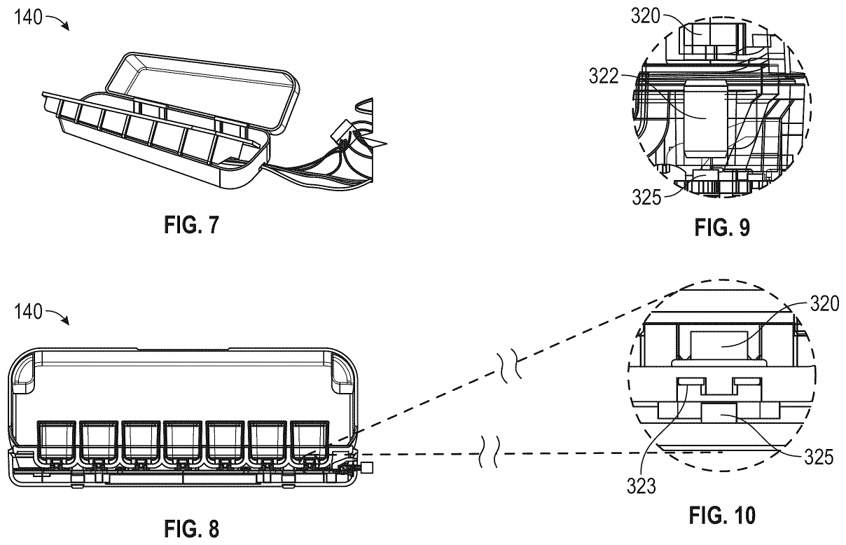

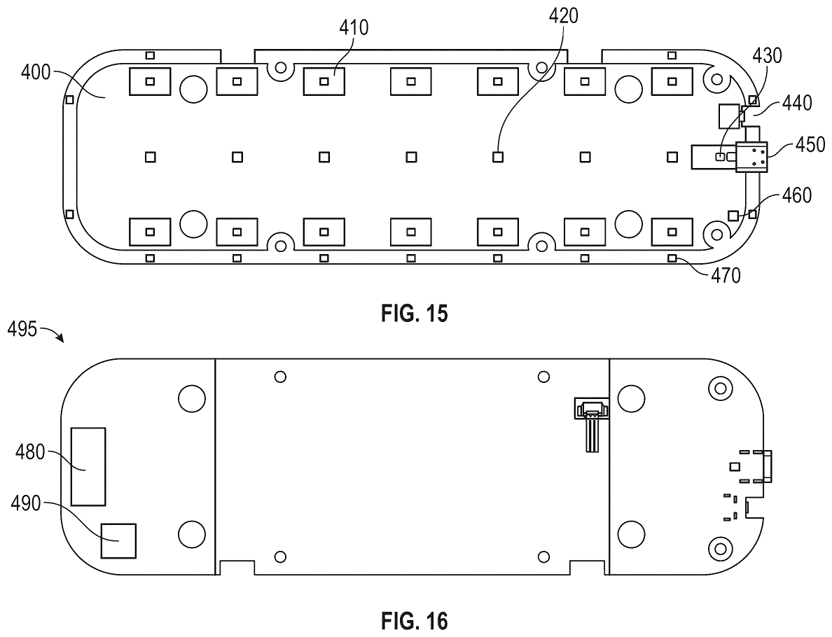

FIG. 1 illustrates a pillbox 100 including lid 110 and bottom part 120, which form the main body of the pillbox. The bottom part 120 includes tray 125 and circuit system 130. The tray 125 includes pockets for receiving cells 140. The lid 110 is connected to the bottom part 120 via a hinge to allow a user to open and close the pillbox 100 to access the cells 140. The tray 125 and the circuit system 130 fit inside the bottom part 120. The pillbox 100 can include additional elements, such as (see FIGS. 7-10) one or more magnets 320, one or more magnetic sensors 325, a battery to power the sensors 325 and the circuit system 130, and a microcontroller. For example (see FIGS. 15-16), the pillbox 100 can include a sensor system that includes one or more lid sensors 460 and a plurality of cell magnetic sensors 420, where the lid sensors 460 are configured to sense opening and closing of the pillbox 100, and where the cell sensors 420 are configured to sense a state associated with each of the plurality of cells 140. Suitable sensors include, for example, Hall effect sensors, which can interact with magnets integrated into the lid 110, the cells 140, or other elements of the pillbox 110. A Hall effect sensor is a sensor that incorporates one or more Hall elements, each of which produce a voltage proportional to one axial component of a magnetic field vector using the Hall effect.

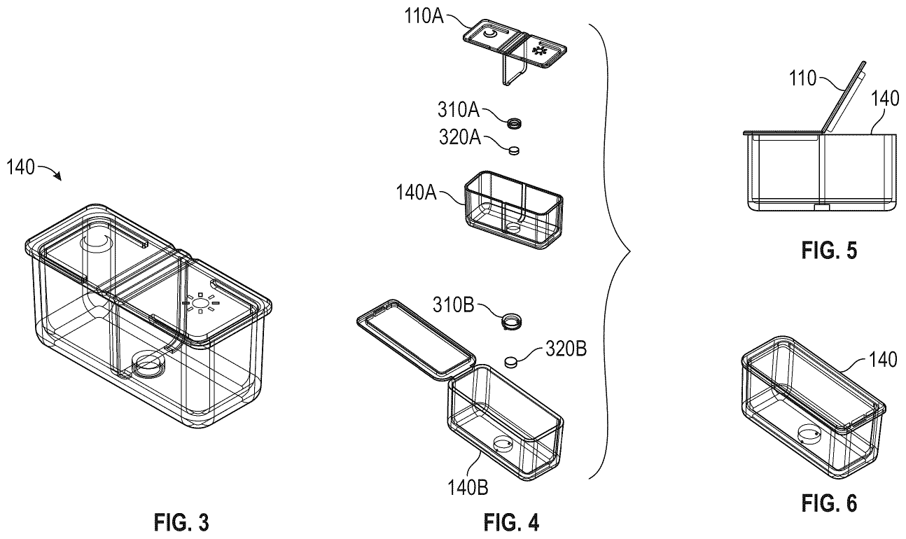

As shown in FIGS. 3-6, each pill cell 140 is molded from polypropylene with embedded neodymium magnets 320. These magnets 320 are seated in a magnet cup 310 at the bottom of the cell 140 to align with the PCB-mounted Hall sensors 420 when the cell 140 is placed. The cell 140 can have material of polypropylene, texture of matte and semi-translucent, magnet size of 6×2 mm, grade N52, and design available in daily or AM/PM configurations. This integration ensures the system can detect whether a specific cell is present (magnet aligned with sensor) or has been lifted (magnet out of range).

As shown in FIGS. 7-10, the sensing system of pillbox 100 can be based on a binary state change from the Hall sensors 420. When placed (in range), the magnet is detected and the cell is registered as present. When lifted (out of range), the magnet is absent and the cell is registered as removed. In certain illustrative embodiments, the components can include a Hall Magnetic Sensor (SL353LT) with a omnipolar digital switch, a magnet that is a Neodymium N52 (6×2 mm), and a metal pin and washer that provides mechanical alignment and support. This architecture avoids mechanical switches, ensuring long-term durability and eliminates potential misreads caused by dust or pill debris.

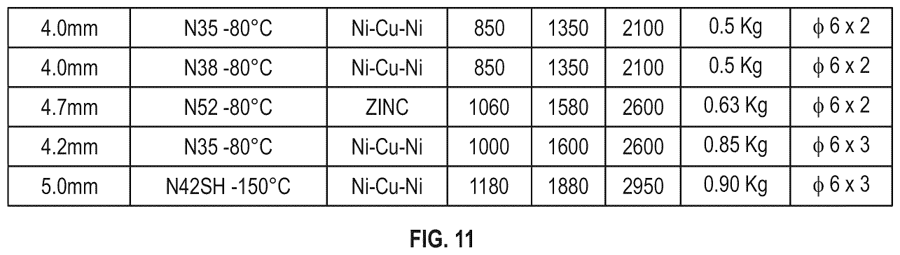

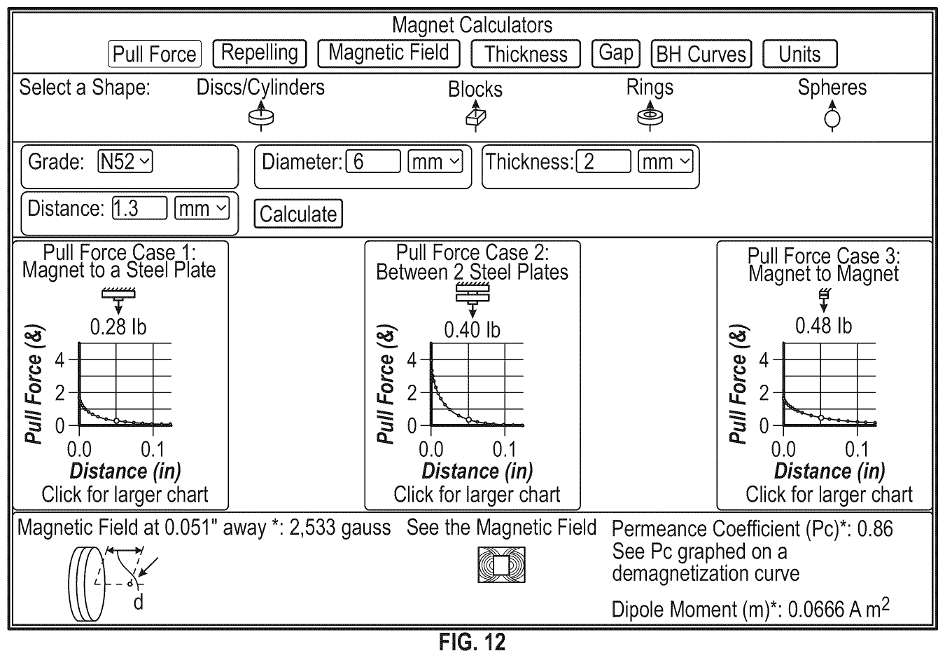

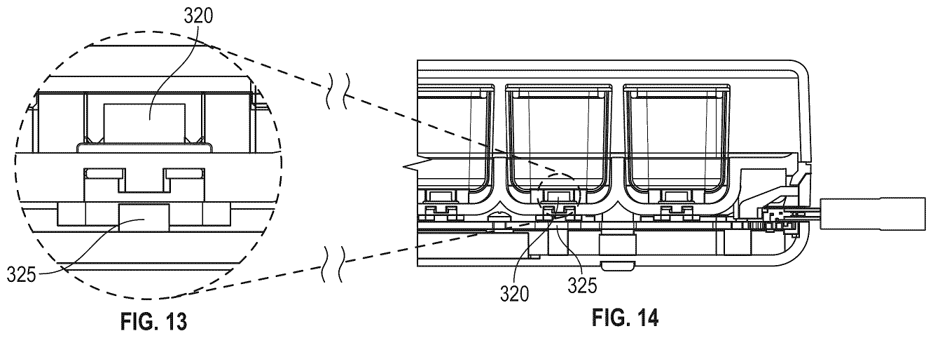

In certain illustrative embodiments, pillbox 100 can have cell magnet properties shown in FIGS. 11-14. Magnet properties can be optimized for reliable detection, although the numbers and specifications provided herein reflect an illustrative embodiment and are non-limiting. The size can be 6 mm diameter×2 mm thickness. The grade can be N52 high-strength neodymium. The separation distance can be 1.3 mm between magnet and sensor. Testing confirmed consistent detection across manufacturing tolerances, with sufficient margin for real-world use while maintaining low power consumption. The microcontroller can interpret each Hall sensor signal as a binary lift/placed event. These events are: (1.) Logged: Each interaction is timestamped and stored. (2.) Feedback-driven: LEDs provide real-time confirmation (e.g., flashing when a cell is lifted). (3.) Synced: Data is transmitted to a smartphone via BLE or uploaded to the cloud via Wi-Fi. This system enables detailed adherence records, supports timely reminders, and powers engagement features like streak-based reward animations. Advantages of the magnetic sensor architecture can include low power: microamp consumption supports multi-week battery life, reliability: contactless detection with no moving parts, compactness: miniaturized design, magnets embedded within cells, mechanical simplicity: no switches, springs, or optical paths, and tamper detection: logs unusual interactions, such as prolonged cell removal.

In certain illustrative embodiments, and in contrast to prior pill organizers that relied on optical beams, weight sensors, or fragile microswitches, the presently disclosed pillbox 100 employs a network of solid-state Hall-effect sensors paired with miniature magnets in each cell to monitor user interactions. Each removable cell 140 carries a small magnet and is positioned above a dedicated Hall sensor on the PCB. The sensor output provides a binary lift/placed signal that registers removal or reinsertion of that specific cell. The microcontroller can read these signals to log each access event, drive LED feedback (for example, confirming the correct cell has been lifted or flagging a delayed return), and synchronize adherence data to the app or cloud. The magnetic sensors can operate with very low power, and continuous monitoring is sustained while maintaining multi-week battery life in a compact device. Moreover, because detection is contactless and has no moving parts, the system is highly reliable, resistant to wear, and immune to dust or pill residue that can impair optical systems. The result is a robust and miniaturized sensing architecture that records every dose interaction and enables features such as streak-based reward animations that improve engagement. By using magnets in the cells and silicon Hall ICs on the PCB rather than complex optics or mechanical switches, the pillbox 100 achieves a commercially significant improvement in accuracy, reliability, and power economy over prior medication dispensers.

In certain illustrative embodiments, hall sensors are used for proximity sensing, positioning, speed detection, and current sensing applications. As shown in FIGS. 15-16, a PCB (printed circuit board) for pillbox 100 can include PCB 400, cell LED 410, cell magnetic sensor 420, battery LED 430, push button 440, UBC-C 450, lid magnetic sensor 460, cell LED 470, antenna 480, processor 490, and battery LED 495.

In certain illustrative embodiments, a Hall-Effect magnetic sensor architecture is incorporated into the pillbox 100. The pillbox 100 leverages miniature magnets embedded in each cell 140 of the pillbox 100 and solid-state Hall sensors 420 mounted on the PCB to provide a robust, low-power, and highly reliable method of detecting cell removal and reinsertion. As illustrated in FIGS. 15-16, the printed circuit board assembly (PCB) 400 hosts the main components of the sensing system. Each pill cell position corresponds to a Hall-effect sensor (SL353LT) that detects the magnetic field from the magnet embedded in the cell 140. The PCB 400 also integrates cell LEDs 470 for user feedback, a push button 440 for manual interaction, a USB-C port 450 for charging, and control circuitry for power management and wireless connectivity.

In certain illustrative embodiments, a certain number of cells 140 are inserted inside the tray 125. For example, there can be seven cells 140, one for each day of the week, as illustrated in FIG. 1. Each cell may include a compartment for holding medication. In some embodiments, each cell 140 includes multiple compartments, e.g., two compartments, one for the morning/day (“AM”) and one for the evening/night (“PM”), and labeled accordingly. Cells 140 can be removable from the tray 125. This allows the user to remove a particular cell 140 with the medication to be taken from the pillbox 100, which can facilitate dispensing of the medication from the cell 140.

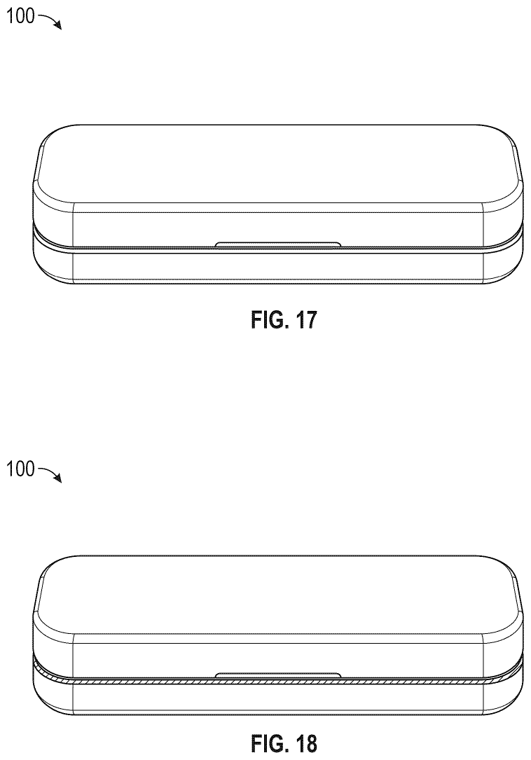

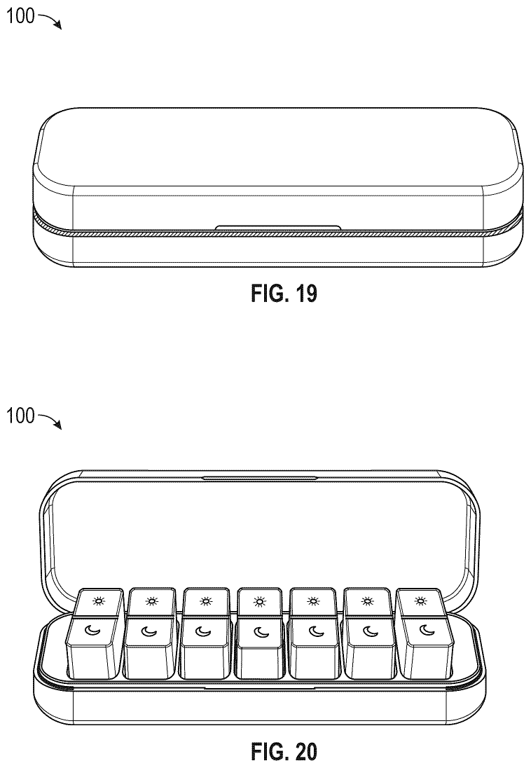

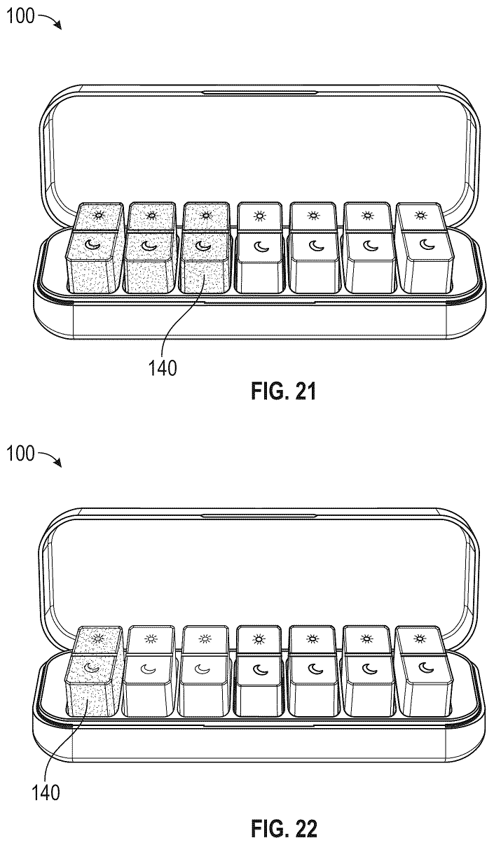

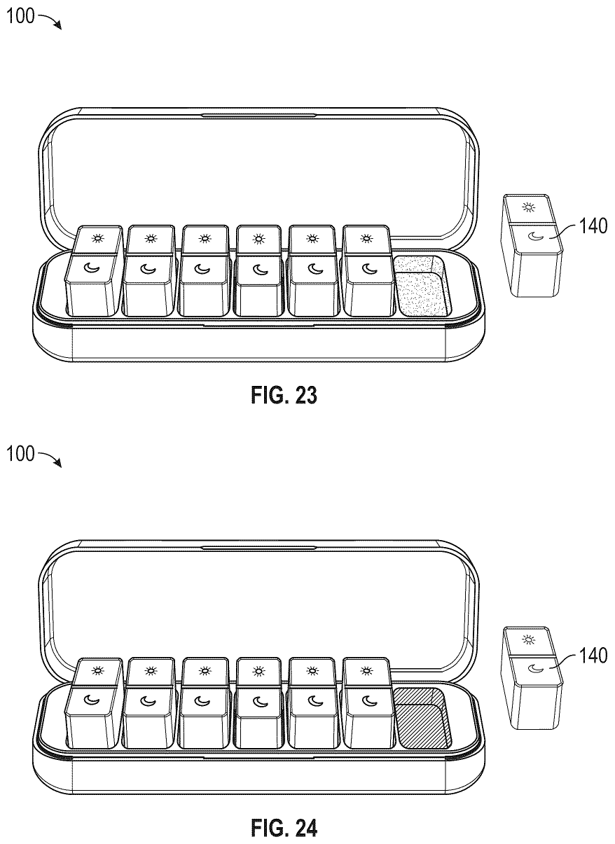

In certain illustrative embodiments, circuit system 130 produces visual signals (for example, different colors of light) to remind a user to perform specific tasks, including refilling the pillbox 100 or taking a pill. In one embodiment, as shown in FIG. 17 and FIG. 18, a visual signal at the housing of the pillbox 100 (e.g., main body, lid, etc.) indicates when it is time to take a pill when the lid is closed (compare FIG. 17 with no indication to shaded/lighted region in FIG. 18 providing an indication of time to take a pill). In one embodiment, as shown in FIG. 20, a visual signal at or near a cell 140 when the pillbox 100 is opened indicates when it is time to take a pill. In one embodiment, as shown in FIG. 21 and FIG. 22, one or more visual signals indicate when pill(s) in a cell 140 have been taken when the pillbox 100 is opened. In one embodiment, as shown in FIGS. 7-10 and FIG. 23 and FIG. 24, in order to determine when the pills in a cell 140 have been taken by the user, the circuit system 130 can detect, e.g., via a magnet 320, metal pin 322 and/or metal plate 323, and magnetic sensor 325, when a cell 140 is removed from the pillbox 100 and can produce a visual signal indicating the cell 140 is removed from the pillbox 100. For example, as shown in FIG. 23, the circuit system 130 produces visual signals (for example, different colors of light) to alert the user of a specific initial status, for example when a cell 140 is taken out of the body of the pillbox 100. Also, as shown in FIG. 24, a visual signal indicates when a cell 140 is taken out of the body for a certain period of time (for example, longer than 30 seconds). In one embodiment, as shown in FIG. 22, one or more visual signals indicate a reward, for example, when a user successfully takes all their medication during the week. For example, the reward can be called “End of week piano reward”, wherein all cells 140 light up from one side of the pillbox 100 to the other side of the pillbox 100, one cell 140 at a time, whereby FIG. 23 shows the first cell 140 in the sequence (Sunday) lit up. A reward animation sequence is performed that sequentially illuminates light emitters associated with the plurality of cells 140 after detecting that a user has complied with a prescription schedule for a predetermined period for medication held in the pillbox 100. The reward animation sequence can include the light emitters lighting up sequentially for each cell 140 in the tray from a first end of the pillbox 100 (near the Sunday tray) to a second end of the pillbox 100 (near the Saturday tray). The light emitters can light up one cell 140 at a time.

In certain illustrative embodiments, the circuit system 130 includes or is operatively coupled to one or more wireless communication interfaces to allow the pillbox 100 to interface with a user's mobile device 201. In some embodiments, the pillbox 100 interfaces with the user's device 201 through a Bluetooth® wireless communication protocol. In some embodiments, the pillbox 100 interfaces with the user's device 201 through a WiFi® wireless communication protocol. The pillbox 100 may use one or more of Bluetooth and WiFi wireless communication protocols depending on the proximity of the pillbox 100 to the user device 201. For example, using the WiFi protocol can allow the pillbox 100 to communicate with a user device 201 that is not in close proximity to the pillbox 100.

In certain illustrative embodiments, a single pillbox 100, comprising for example 1×7, 2×7, 3×7, etc. cells, may be used to manage pills on a weekly basis (medication schedule once, twice or three times, etc. a day for one week). Filling of the pillbox 100 may be performed manually by a user or a user's guardian (or a caregiver or a healthcare provider) or by a machine at the pharmacy or other third party. Cells 140 may be used individually for storing medication.

As used herein, the term “medication schedule” refers to a set of data defining the dose times for a user. For example, a medication schedule may indicate that a user should take their medications in the morning and evening, or in the morning, afternoon, and evening. The medication schedule does not identify the specific medications stored in the wells of the pillbox 100. The term “medication regimen,” as used herein, refers to a set of data that includes the medication schedule and additional information related to the medications, such as the medication name, dose, and prescribing instructions (beyond the dose time, which is part of the medication schedule). This may include instructions on taking medication with or without food, handling missed doses, contraindications, prescribing doctor, and more. The medication regimen may be provided by one or more doctors or other medical providers and can be updated by these providers as needed.

### App. on User Device

The pillbox 100 may communicate via one or more networks with an application (“App”) on a user's device 201, such as a computer, laptop, smartphone, or tablet, or with a central processing center accessible through these networks. The presently disclosed system records when the user takes their medication, sends reminders to take medication, provides a dashboard displaying the user's medication schedule and adherence history, records the user's health status, for example measurable vital signs, and facilitates communication between the user or the user's guardian and their care community.

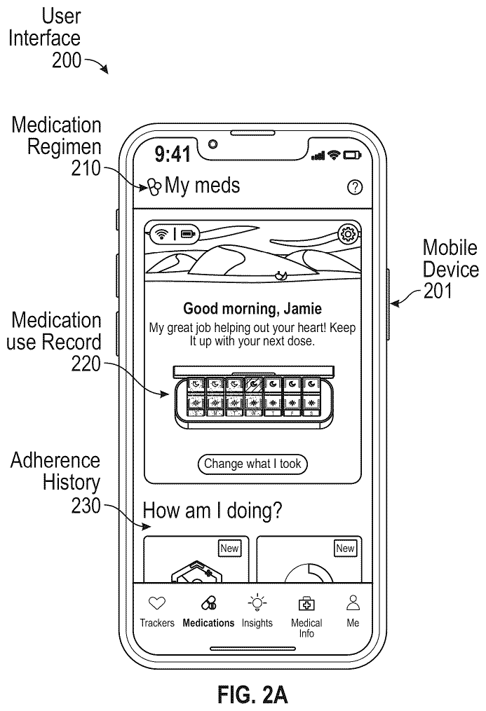

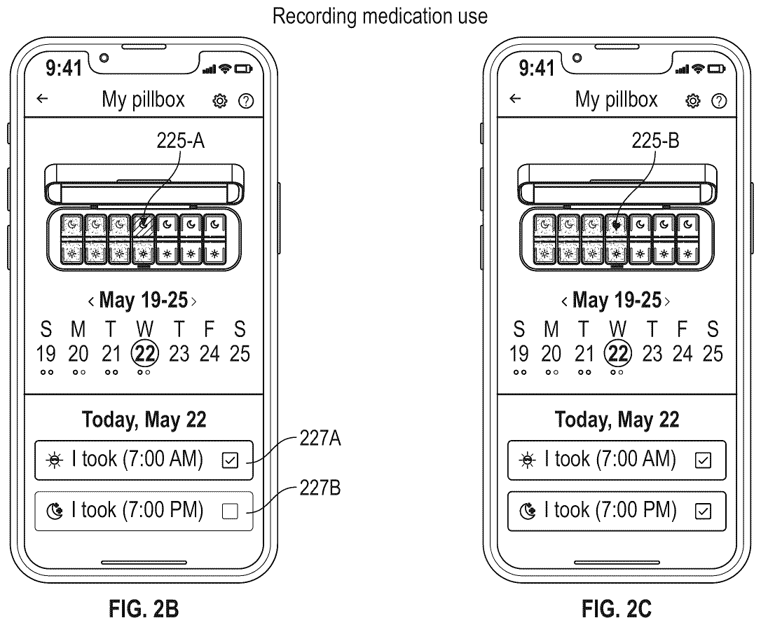

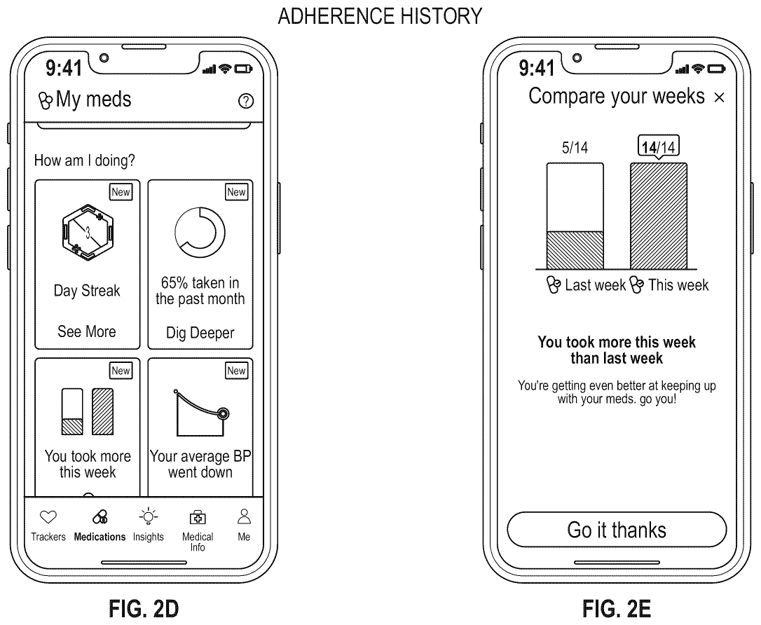

FIGS. 2A-2E are schematic figures illustrating example embodiments of the presently disclosed subject matter. The example embodiment in FIG. 2A is user interface 200, running on user's mobile device 201, defining medication regimen 210, medication use record 220 and adherence history 230. Bottom part 120 (as displayed on user interface 200) includes tray 125 and circuit system 130. Tray 125 includes cells 140. FIGS. 2B-2C illustrate recordation of medication use by a user. In FIG. 2B, Box 227A is checked and indicates that the user took the morning dose. Cell 225-A corresponds to evening medication schedule on a particular day (“May 22”) and is lit up with a color, e.g., white light, indicating that it should be taken by the user. FIG. 2C illustrates that once the user takes the medication and checked box 227B, cell 225-B lights up in another color, e.g., green. The example embodiments in FIG. 2D illustrate exemplary options to review adherence history, for example, by number of days of adherence (day streak), adherence over the past month (for example, 65% of medication schedule was fulfilled), comparison between different time points (for example, current week compared with the past week) and health outcomes (for example, controlled blood pressure). FIG. 2E illustrates a comparison between the number of pills taken last week (5/14) and this week (14/14).

Recordation of medication use may be adjusted by the user, the user's guardian, or their care community. The presently disclose App may send reminders to the user's device at a certain time point prior to medication dose time. The user may choose to give permission to send reminders to their care community. The user may record the use of a medication dose manually, for example by checking a box corresponding to the medication dose. A history of medication use may be recorded on the user's device.

In certain illustrative embodiments, the user may record their health status, for example vital signs, on the system. Vital signs in humans are quantifiable indicators of essential physiological functions. These signs are critical for assessing the general health status of an individual and can provide valuable data for tracking medication adherence. Examples of vital signs in humans include, but are not limited to, heart rate (pulse), blood pressure, respiratory rate, body temperature, oxygen saturation (SpO₂), and blood glucose levels. In some embodiments, a user's health outcomes are demonstrated as trends of vital signs over a specific period of time (e.g., current week compared with the previous week). A user may receive feedback about trends in vital signs or biomarkers, such as exemplified in FIG. 2D, which shows a user interface displaying a graph illustrating a downward trend in average blood pressure (BP). In the example shown in FIG. 2D, one or more graphs illustrating health outcomes, e.g., trends in vital signs, may be juxtaposed with one or more graphs illustrating trends in medication adherence. Moreover, the system can be operatively coupled to a blood pressure measurement device 300 and configured to receive communication from the blood pressure measurement device 300 regarding blood pressure data of the user, and the blood pressure data can be used to determine the upward or downward trend in average blood pressure.

In certain illustrative embodiments, the presently disclosed subject matter also relates to digital health analytics and, more particularly, to computerized techniques that detect and quantify relationships between blood pressure (BP) and medication exposure and/or adherence using consumer-grade mobile applications and back-end services. Mobile health platforms increasingly collect longitudinal biometric measurements (e.g., systolic and diastolic BP) alongside medication data. Conventional systems either (i) show raw time series without statistical interpretation, or (ii) compute global adherence metrics without establishing a per-user, time-aligned relationship between medication signals and BP. There is a need for scalable techniques that: (a) normalize heterogeneous records into aligned timelines; (b) compute per-user correlations that satisfy data-quality constraints; (c) detect causal-adjacent patterns around medication start events; and (d) aggregate the per-user findings into population-level insights suitable for end-user messaging and clinical decision support.

In one aspect, a computer-implemented method constructs, for each user, synchronized timelines of (i) BP measurements and (ii) medication signals that include tracked adherence and consumed adherence. The system bins records by a defined interval (e.g., week) and calculates correlation metrics (e.g., Pearson) subject to data sufficiency and variability constraints. A correlation is deemed significant when it exceeds a configurable threshold and is consistent in sign with the hypothesized relationship. Output cards classify the relation and trend using the two most recent bins.

In another aspect, a before/after analysis detects BP changes surrounding a medication-add event. For each pair of BP records within a defined temporal proximity to a medication-add event, the system compares median BP values in pre- and post-event windows and applies effect-size thresholds. Users meeting predefined improvement criteria are counted, and population-level summaries (e.g., fraction improved, mean median reduction) are emitted as a “sneak peek” aggregation.

In certain illustrative embodiments, insights have a defined validity window (e.g., seven days from creation) and a time-to-live (e.g., ninety days) controlling refresh and expiration.

As used herein, dependent variable means a BP metric (e.g., systolic in mmHg; optionally diastolic), independent variable means a medication signal (e.g., tracked compliance, consumed compliance, or medication-add event) and optionally covariates (e.g., activity), tracked compliance means for a given day, 1 if the user recorded whether they took or did not take a required medication; otherwise 0, consumed compliance means for a given day, 1 if the user recorded taking the required medication; otherwise 0, weekly compliance means per-user weekly average of daily compliance scores aggregated across medications, medication-add event means creation of a medication record indicating the start of a drug regimen, and bin means an aggregation interval (e.g., one week) over which records are averaged.

Moreover, all references to medication data herein should be interpreted generically as a medication records datastore and scope is not tied to specific schemas or legacy tables. UI identifiers and card names should be seen as exemplary encodings. The embodiments described herein include on-device, cloud, and federated variants.

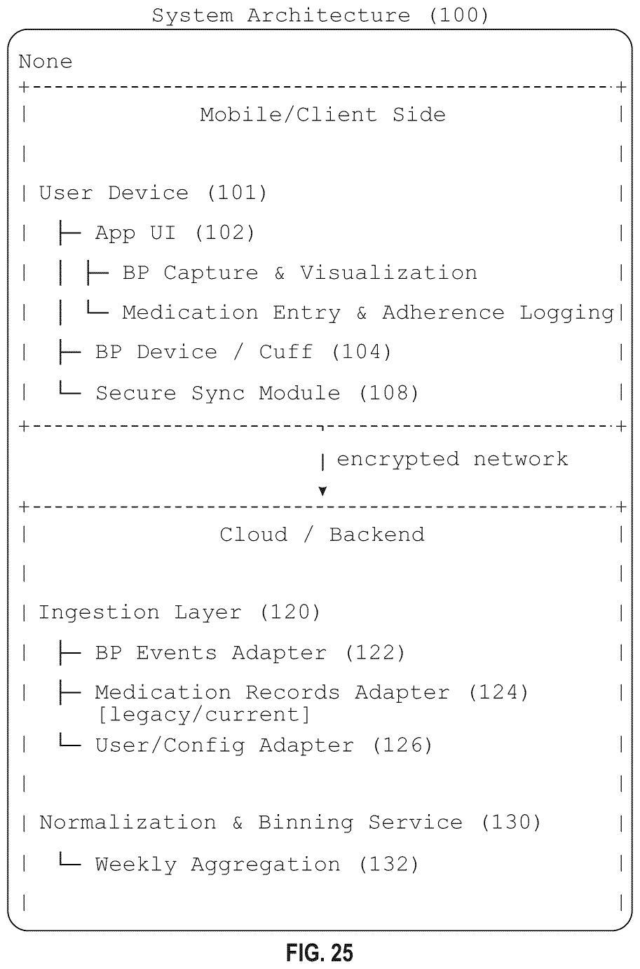

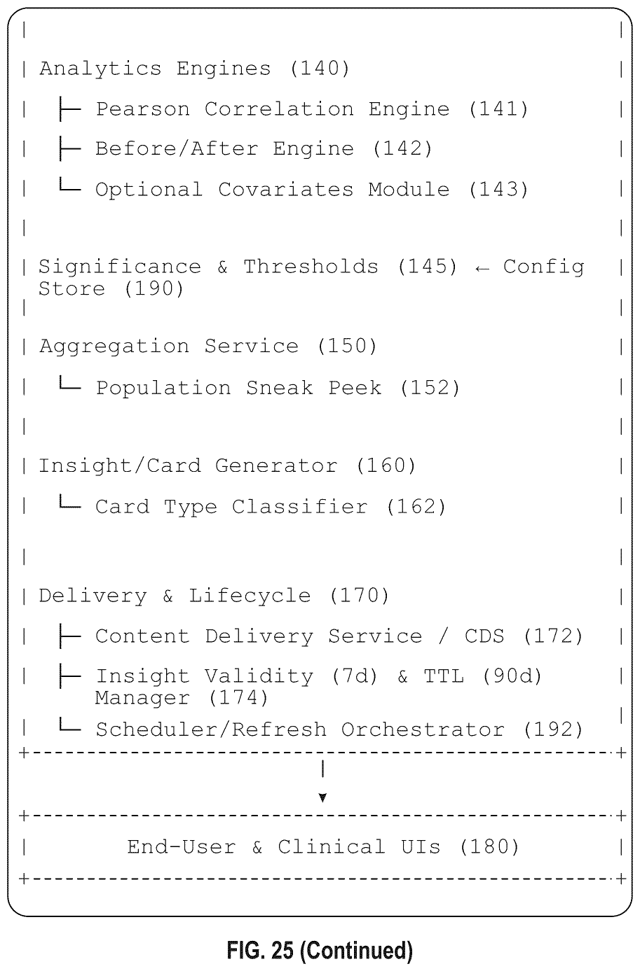

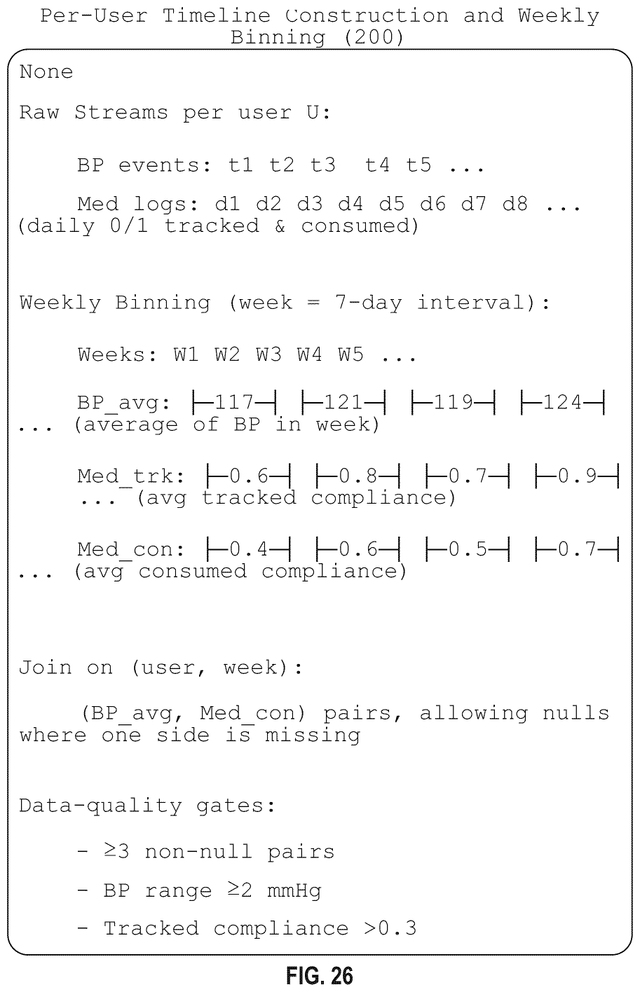

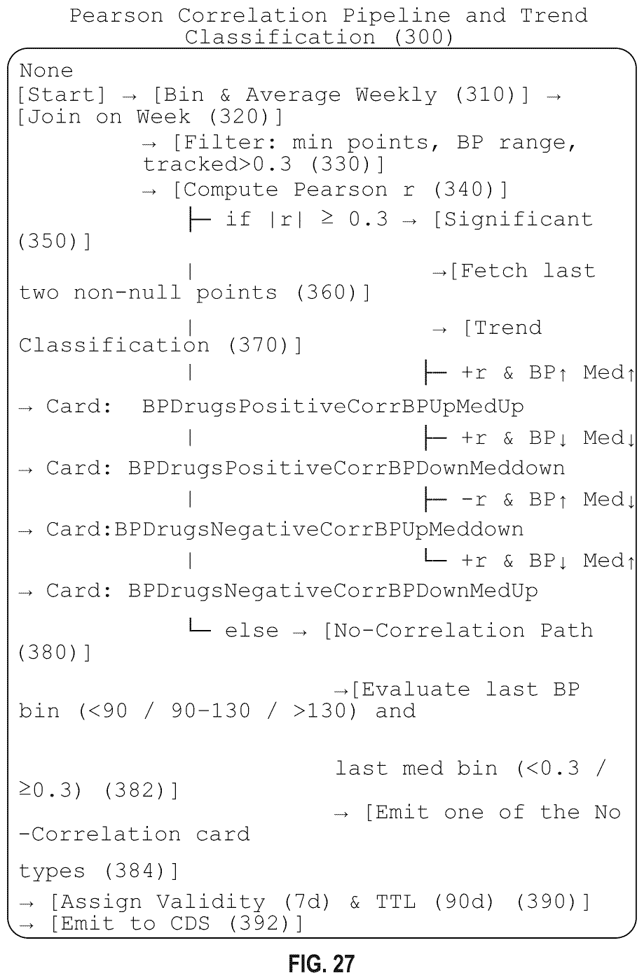

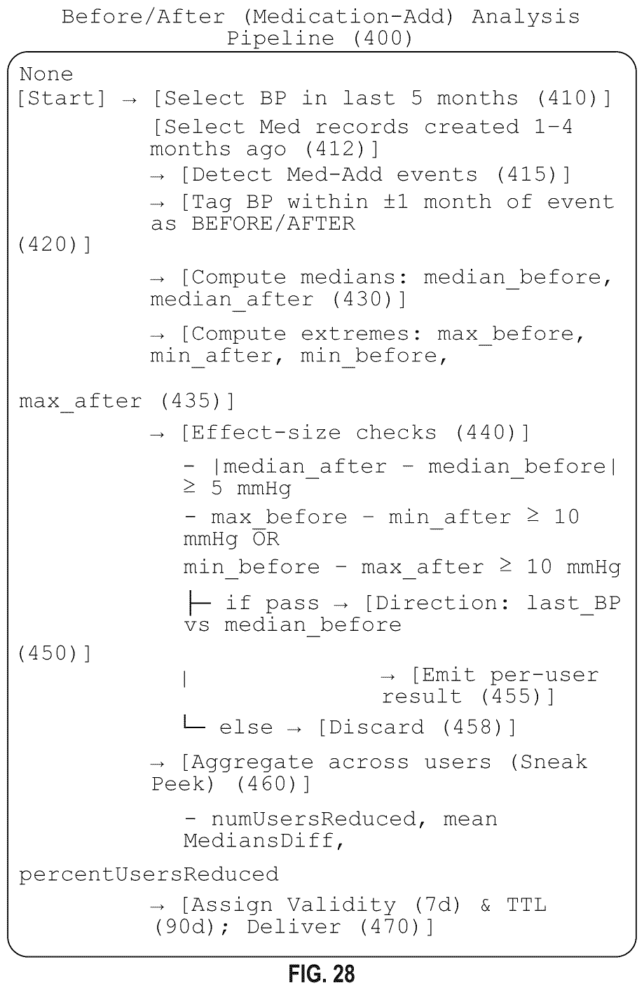

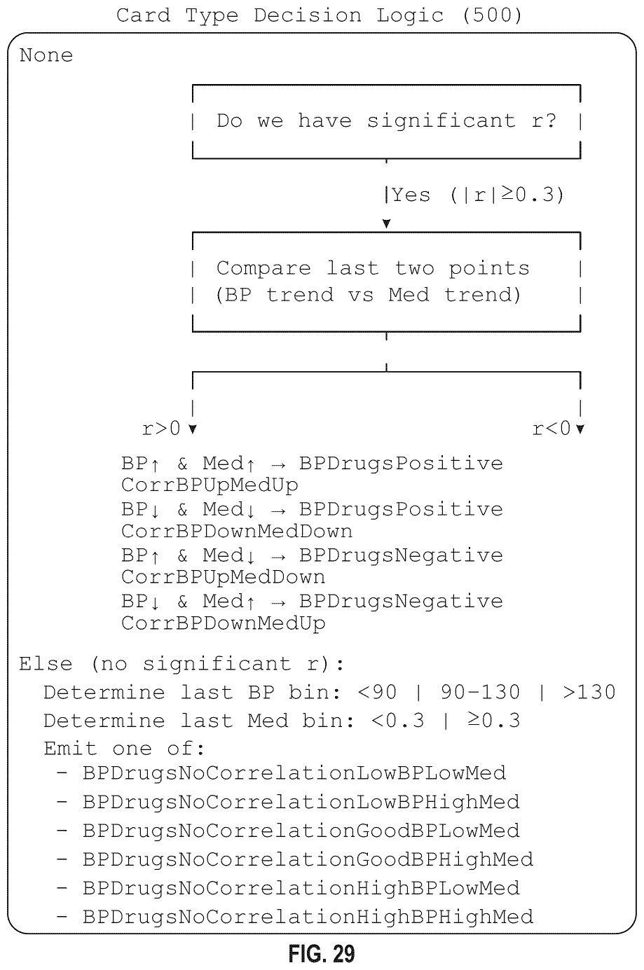

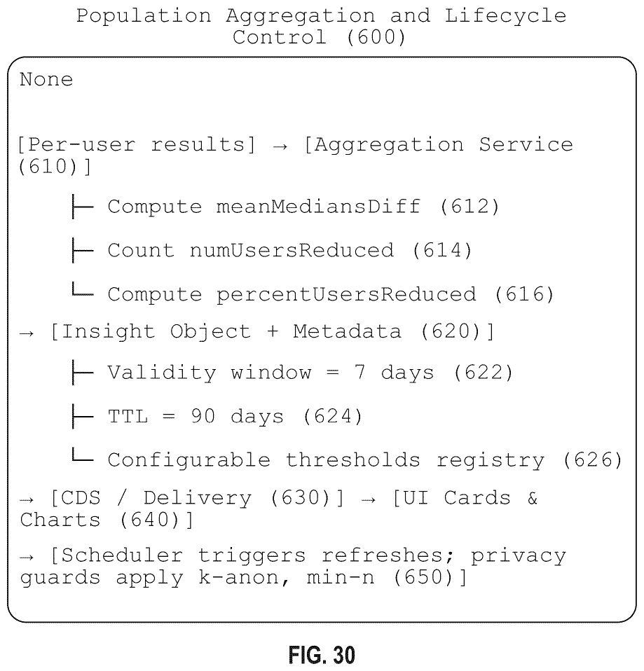

FIG. 25 is a block diagram of a system architecture for ingesting BP and medication records and producing insights in accordance with an illustrative embodiment of the presently disclosed subject matter. FIG. 26 illustrates per-user timeline construction and weekly binning in accordance with an illustrative embodiment of the presently disclosed subject matter. FIG. 27 is a flowchart of the Pearson correlation pipeline with significance gating and trend labeling in accordance with an illustrative embodiment of the presently disclosed subject matter. FIG. 28 is a flowchart of the before/after pipeline around medication-add events in accordance with an illustrative embodiment of the presently disclosed subject matter. FIG. 29 depicts card-type classification logic for positive, negative, and no-correlation cases in accordance with an illustrative embodiment of the presently disclosed subject matter. FIG. 30 illustrates population-level aggregation (“sneak peek”) and lifecycle management in accordance with an illustrative embodiment of the presently disclosed subject matter.

### Data Ingestion and Normalization

In certain illustrative embodiments, the system receives BP measurements (timestamp, user identifier, systolic/diastolic values) and medication records (timestamp, user identifier, drug identifier, adherence entries). Records may originate from legacy or current medication data stores. A normalization service converts records into canonical form and assigns them to weekly bins. Multiple measurements within a bin are averaged.

### Per-User Timeline Construction

For each user, the system builds aligned sequences of (i) binned BP and (ii) a binned medication signal. Missing values are allowed; joins are performed on (user, bin). Bins lacking values for one variable are joined with nulls.

### Pearson Correlation Pipeline (BP vs Medication Adherence)

1. Binning: aggregate BP and medication adherence by week, up to a quarter (e.g., ˜13 weeks).

### Compliance Signals

Tracked compliance: daily indicator∈{0,1}, averaged by week across medications.

Consumed compliance: daily indicator∈{0,1}, averaged by week across medications.

2. Filtering.

Minimum joint non-null points per user: ≥3.

Minimum dependent-variable range (BP): ≥2 units.

Minimum tracked compliance level: weekly average>0.3.

3. Computation: compute Pearson correlation coefficient r between weekly BP and weekly consumed compliance.

4. Significance: correlations are tagged significant if |r|≥0.3 (threshold configurable and sign-aware).

5. Trend labeling: emit the last two non-null points for each variable and classify trend direction. Card types include:
BPDrugsPositiveCorrBPUpMedUp
BPDrugsPositiveCorrBPDownMedDown
BPDrugsNegativeCorrBPUpMedDownBPDrugsNegativeCorrBPDownMedUp

No-correlation variants based on last BP bin (<90, 90-130, >130 mmHg) and last medication compliance bin (<0.3 or ≥0.3).

6. Validity and TTL: insight validity 7 days post-creation; TTL 90 days.

FIG. 31 illustrates an example output (negative correlation; BP down, medication up) for a Pearson correlation pipeline (BP vs medication adherence) in accordance with an illustrative embodiment of the presently disclosed subject matter.

### Before/After Pipeline (BP vs Medication-Add Events)

1. Data windows:

BP: all BP records within the last five months for a user.

Medication: medication records created between one and four months prior to the analysis time.

2. Pairing: for each medication-add event, identify BP records within ±1 month of the event and tag each BP as before or after the event.

3. Statistics:

Compute median BP for the before window and the after window.

Compute extreme-shift metrics: (max_before−min_after) and (min_before−max_after) magnitudes.

4. Effect-size thresholds (configurable):

Median difference|median_after−median_before|≥5 mmHg.

At least one extreme-shift magnitude≥10 mmHg.

5. Direction labeling: compare the last available BP to the before-median to label increase/decrease.

6. Emission criteria: only emit cases meeting both thresholds. Emit per-user direction and effect size.

7. Population aggregation (sneak peek): count users with reduced BP after the medication-add event; compute mean of per-user (median_before−median_after); report percentage relative to all evaluated users.

8. Validity: insight validity 7 days from creation; TTL 90 days.

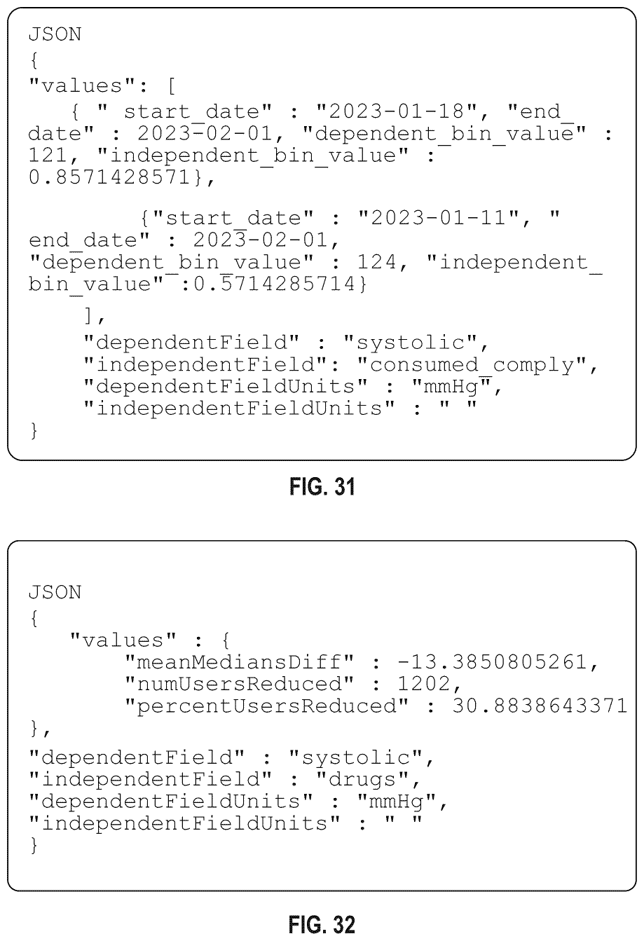

FIG. 32 illustrates an example output (sneak peek) for a Before/After pipeline (BP vs medication-add events) in accordance with an illustrative embodiment of the presently disclosed subject matter.

### Optional Covariates

In some embodiments, additional independent variables (e.g., weekly average steps from the past year) are computed using the same binning and joining framework to support multivariate analysis, sensitivity analysis, or stratification.

### Implementation Considerations

The presently disclosed subject matter works with legacy and current medication data stores; schemas are abstracted by an ingestion layer, thresholds (min points, min delta, r-thresholds, medians and extreme-shift thresholds) are centrally configurable per population, drug class, or user segment, and the pipelines are stateless between runs; lifecycle metadata controls refresh and expiry.

### Advantages

The presently disclosed subject matter produces interpretable, per-user correlation insights with explicit data-quality gates, detects clinically meaningful BP shifts around therapy initiation using effect-size thresholds, and aggregates to population-level metrics suitable for product messaging and clinical reporting.

### Privacy and Security

All computations can be executed on de-identified datasets with results reported in aggregate or via privacy-preserving thresholds.

In certain illustrative embodiments, a computer-implemented method is provided. The method can include receiving, for each of a plurality of users, blood pressure measurements comprising timestamps and systolic values; receiving medication adherence signals comprising daily indicators of tracked compliance and consumed compliance; binning the blood pressure measurements and the medication adherence signals by a common temporal interval to form per-user binned sequences; joining, per user, the binned blood pressure sequence with the binned adherence sequence by temporal interval to create joint sequences having non-null pairs and nulls otherwise; filtering the joint sequences to retain users having at least three non-null pairs, a blood-pressure range of at least two units, and an average tracked compliance exceeding 0.3; computing, for each retained user, a Pearson correlation coefficient between the binned blood pressure sequence and the binned consumed compliance sequence; labeling a correlation as significant when an absolute value of the coefficient is at least 0.3; and classifying a trend using last two non-null binned values of each sequence to produce one of: positive-correlation BP-up/medication-up, positive-correlation BP-down/medication-down, negative-correlation BP-up/medication-down, negative-correlation BP-down/medication-up, or a no-correlation class stratified by last blood-pressure bin and last adherence bin. In certain aspects, the temporal interval is one week and the consumed compliance for a week is an average over daily medication-consumption indicators across all medications. The method can further comprise assigning an insight validity period of seven days from creation and a time-to-live of ninety days. The blood pressure measurements can comprise diastolic values and the method is performed for systolic, diastolic, or both.

In certain illustrative embodiments, a computer-implemented method is provided. The method can include: identifying a medication-add event for a user from medication records created between one and four months before an analysis time; selecting the user's blood pressure measurements in a window spanning at least five months and tagging each measurement as before or after the medication-add event when within one month of the event; computing a before-window median and an after-window median of blood pressure; determining an effect size by requiring: an absolute difference between the medians of at least 5 mmHg, and at least one of a maximum-before to minimum-after difference or a minimum-before to maximum-after difference of at least 10 mmHg; and upon satisfying the effect-size requirements, emitting a result comprising the direction of change determined by comparing a most-recent blood pressure to the before-window median. The method can further comprise aggregating results across users to compute a count of users with reduced blood pressure after the medication-add event, a mean of per-user median differences, and a percentage relative to all evaluated users. The tagging window is configurable and defaults to plus or minus one month. The method can further comprise aggregating per-user results into a population-level insight that includes at least one of: a fraction of users satisfying a significance or effect-size criterion, and an average effect magnitude.

In certain illustrative embodiments, a system is provided that comprises one or more processors 490 and memory storing instructions which, when executed, cause the system to perform any of the aforementioned methods, and further to generate user-interface cards that encode correlation class and trend based on the last two binned points.

In certain illustrative embodiments, a non-transitory computer-readable medium is provided that stores instructions that, when executed by one or more processors 490, cause the processors 490 to perform any of the aforementioned methods.

In certain illustrative embodiments, alternative correlation methods (e.g., last-vs-past, high-vs-low via independent-variable mean split) can be substituted for Pearson while preserving the data-quality gates and classification scheme. Also, independent variables may include additional medication-exposure features (dose changes, polypharmacy indicators) and lifestyle covariates (e.g., activity) computed via the same binning and joining framework. Moreover, thresholds and windows are tunable per drug class, population segment, or individual.

In certain illustrative embodiments, the care community may include, for example, healthcare providers, guardians, family members, close friends, trusted individuals and insurance providers. In some embodiments, a user may choose to share the adherence history with their care community, for example, with their healthcare provider. Healthcare providers may include physicians, nurses, physician assistants and pharmacists. The care community may be designated by the user or user's guardian to have access to information about the user's medication schedule and/or adherence history. The user or the user's guardian may designate the members of the care community at the time of registering or any time during. The care community may be designated by the user or user's guardian to adjust the medication schedule or medication regimen.

Various illustrative embodiments of a system for tracking and guiding a person's medication usage using a smart pillbox 100 are described herein.

In certain illustrative embodiments, a pillbox 100 is provided. The pillbox 100 can include: a main body including a tray 125; a plurality of cells 140 receivable in the tray 125 of the main body, each cell 140 configured to hold medication; a lid 110 movably coupled to the main body and configured to open and close the pillbox 100; a sensor system comprising a lid sensor and a plurality of cell sensors 420, the lid sensor configured to sense opening and closing of the pillbox 100, wherein the plurality of cell sensors 420 are configured to sense a state associated with each of the plurality of cells 140; and circuitry operatively coupled to the sensor system and configured to take an action in response to one or more signals received from the lid sensor, the cell sensors 420, or both the lid 110 and cell sensors 420, wherein the action comprises a reward animation sequence that sequentially illuminates light emitters associated with the plurality of cells 140 after detecting that a user has complied with a prescription schedule for a predetermined period for medication held in the pillbox 100.

In certain aspects, the prescription schedule can include the user taking all of the medication held in the plurality of cells 140. The predetermined period can comprise a full seven-day schedule. The reward animation sequence can include the light emitters lighting up sequentially for each cell 140 in the tray 125 from a first end of the pillbox 100 to a second end of the pillbox 100. The light emitters can light up one cell 140 at a time. Each of the plurality of cells 140 can contain a permanent magnet, and each of the plurality of cell sensors 420 can include a Hall-effect sensor, and within each of the plurality of cells 140, the Hall effect sensor can be configured to sense a magnetic field associated with the permanent magnet and sense opening or closing of the pillbox 100. The pillbox 100 can further include a plurality of Hall-effect sensors positioned beneath the tray 125, wherein each Hall-effect sensor can be configured to sense insertion or removal of a corresponding cell 140 from the plurality of cells 140. The pillbox 100 can further include a rechargeable lithium-ion battery sized to power the pillbox 100 for at least thirty days of operation at a duty cycle of one wi-fi synchronization per day. The pillbox 100 can further include an indication system operatively coupled to the circuit system 130, the indicating system including: an LED beacon configured to provide a visual indication of a state associated with the pillbox 100; and a plurality of LED indicators, each LED indicator associated with a cell 140 of the plurality of cells 140. The LED indicators can include addressable RGB (red, green blue) LEDs.

In certain illustrative embodiments, a pillbox 100 is provided that can include: a main body including a tray 125; a plurality of cells 140 receivable in the tray of the main body, each cell 140 configured to hold medication; a lid 110 movably coupled to the main body and configured to open and close the pillbox 100; a sensor system; and circuitry 130 operatively coupled to the sensor system. The sensor system can include a lid sensor 460 and plurality of cell sensors 420, whereby the lid sensor 460 can be configured to sense opening and closing of the pillbox 100, and the cell sensors 420 can be configured to sense a state associated with each of the plurality of cells 140. The circuitry 130 can be configured to take an action in response to one or more signals received from the lid sensor 460, the cell sensors 420, or both the lid 110 and cell sensors 420.

In certain aspects, the pillbox 100 can further include an indication system operatively coupled to the circuitry 130. The indication system can include an LED beacon configured to provide a visual indication of a state associated with the pillbox 100. The indication system can include a plurality of LED indicators, each LED indicator associated with a individual cell 140 of the plurality of cells 140. The pillbox 100 can include a communication system operatively coupled to the circuitry 130 and configured to provide wireless communication with a user device 201.

In certain illustrative embodiments, a system for monitoring a user's adherence to a medication schedule is provided. The system can include a pillbox 100 which includes: a main body including a tray 125, a plurality of cells 140 receivable in the tray 125 of the main body, each cell 140 configured to hold medication, a lid 110 movably coupled to the main body and configured to open and close the pillbox 100, a sensor system including a lid sensor 460 and a plurality of cell sensors 420, the lid sensor 460 configured to sense opening and closing of the pillbox 100 and the plurality of cell sensors 420 configured to sense a state associated with each of the plurality of cells 140, and circuitry operatively coupled to the sensor system and configured to take an action in response to one or more signals received from the lid sensor 460, the cell sensors 420, or both the lid sensors 460 and cell sensors 420. The system can also include a user device 201 comprising a processor 490 and a display 495, wherein the processor 490 is configured to communicate with the pillbox 100 and display information about the pillbox 100 via the display 495.

In certain aspects, the processor can be configured to display, via the display, information indicative of medication use by the user and information indicative of one or more health outcomes associated with the user, wherein the one or more health outcomes can include an upward or downward trend in average blood pressure. The system can be operatively coupled to a blood pressure measurement device and configured to receive communication from the blood pressure measurement device regarding blood pressure data of the user, and the blood pressure data can be used to determine the upward or downward trend in average blood pressure. The processor 490 can be configured to determine medication use by the user based on information communicated with the pillbox 100, thereby monitoring the user's adherence to a medication schedule. The processor 100 can be configured to determine the user's adherence to the medication schedule and display information about the adherence to the medication schedule via the display 495. The adherence to a medication schedule can include a consecutive streak of days where the medication was taken. The adherence to a medication schedule can also include a percentage of days where the medication was taken over a single time period. The adherence to a medication schedule can also include a comparison between the number of pills taken between at least two different time periods.

In addition, the circuitry can include a Bluetooth low energy transceiver and a wi-fi transceiver, and the circuity can be configured to communicate adherence data to the user device via the Bluetooth low energy transceiver when the user device is within a predefined range. The circuitry can also be configured to communicate adherence data to a remote cloud server via the wi-fi transceiver when the user device is outside the predefined range for at least ten minutes. The circuitry can also be configured to calculate an adherence metric locally when no network connection is available and to synchronize the metric with the remote server upon re-establishing either Bluetooth low energy or wi-fi connectivity.

In certain illustrative embodiments, a system for monitoring a user's adherence to a medication schedule is provided. The system can include: a pillbox 100 according to the present disclosure; and a user device including a processor 490 and a display 495, wherein the processor 490 is configured to communicate with the pillbox 100 and display information about the pillbox 100 via the display 495.

Unless defined otherwise, all technical and scientific terms used herein have the same meaning as commonly understood by one of ordinary skill in the art to which this invention is related.

The terms “a” or “an” as used herein in the specification may mean one or more. As used herein in the claim(s), when used in conjunction with the word “comprising”, the words “a” or “an” may mean one or more than one. As used herein “another” may mean at least a second or more.

The term “comprise,” or variations such as “comprises” or “comprising,” as used herein may be used to imply the inclusion of a stated element or integer or group of elements or integers, but not the exclusion of any other element or integer or group of elements or integers.

Reference throughout this specification to “one embodiment”, “an embodiment” or “some embodiments” means that a particular feature, structure or characteristic described in connection with the embodiment is included in at least one embodiment of the present invention. Thus, the appearances of the phrases “in one embodiment”, “in an embodiment” or “some embodiments” in various places throughout this specification are not necessarily all referring to the same embodiment(s). Furthermore, the particular features, structures, or characteristics may be combined in any suitable manner in one or more embodiments.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

The teachings of all patents, published applications and references cited herein are incorporated by reference in their entirety.

Diagrams shown herein are schematic; module boundaries may be implemented in software, firmware, or hardware and distributed across services. Reference numerals are illustrative and non-limiting.

While the disclosed subject matter has been described in detail in connection with a number of embodiments, it is not limited to such disclosed embodiments. Rather, the disclosed subject matter can be modified to incorporate any number of variations, alterations, substitutions or equivalent arrangements not heretofore described, but which are commensurate with the scope of the disclosed subject matter.

Additionally, while various embodiments of the disclosed subject matter have been described, it is to be understood that aspects of the disclosed subject matter may include only some of the described embodiments. Accordingly, the disclosed subject matter is not to be seen as limited by the foregoing description, but is only limited by the scope of the claims.

It is to be understood that the described subject matter is not limited to the exact details of construction, operation, exact materials, or illustrative embodiments shown and described, as modifications and equivalents can be apparent to one skilled in the art. Accordingly, the subject matter is therefore to be limited only by the scope of the appended claims.

1. A pillbox, comprising:
a main body including a tray;
a plurality of cells receivable in the tray of the main body, each cell configured to hold medication;
a lid movably coupled to the main body and configured to open and close the pillbox;
a sensor system comprising a lid sensor and a plurality of cell sensors, the lid sensor configured to sense opening and closing of the pillbox, and the plurality of cell sensors configured to sense a state associated with each of the plurality of cells; and
circuitry operatively coupled to the sensor system and configured to take an action in response to one or more signals received from the lid sensor, the cell sensors, or both the lid and cell sensors,
wherein the action comprises a reward animation sequence that sequentially illuminates light emitters associated with the plurality of cells after detecting that a user has complied with a prescription schedule for a predetermined period for medication held in the pillbox.

2. The pillbox of claim 1, wherein the prescription schedule comprises the user taking all of the medication held in the plurality of cells, and wherein the predetermined period comprises a full seven-day schedule.

3. The pillbox of claim 1, wherein the reward animation sequence comprises the light emitters lighting up sequentially for each cell in the tray from a first end of the pillbox to a second end of the pillbox.

4. The pillbox of claim 3, wherein light emitters light up one cell at a time.

5. The pillbox of claim 1, wherein each of the plurality of cells contains a permanent magnet, and wherein each of the plurality of cell sensors comprises a Hall-effect sensor, and wherein within each of the plurality of cells, the Hall effect sensor is configured to sense a magnetic field associated with the permanent magnet and sense opening or closing of the pillbox.

6. The pillbox of claim 1, further comprising a plurality of Hall-effect sensors positioned beneath the tray, wherein each Hall-effect sensor is configured to sense insertion or removal of a corresponding cell from the plurality of cells.

7. The pillbox of claim 1, further comprising a rechargeable lithium-ion battery sized to power the pillbox for at least thirty days of operation at a duty cycle of one Wi-Fi synchronization per day.

8. The pillbox of claim 1, further comprising an indication system operatively coupled to the circuitry, the indicating system comprising: an LED beacon configured to provide a visual indication of a state associated with the pillbox; and a plurality of LED indicators, each LED indicator associated with a cell of the plurality of cells.

9. The pillbox of claim 8, wherein the LED indicators comprise addressable RGB LEDs.

10. A system for monitoring a user's adherence to a medication schedule, the system comprising:
a pillbox comprising:
a main body including a tray,
a plurality of cells receivable in the tray of the main body, each cell configured to hold medication,
a lid movably coupled to the main body and configured to open and close the pillbox,
a sensor system comprising a lid sensor and a plurality of cell sensors, the lid sensor configured to sense opening and closing of the pillbox, and the plurality of cell sensors configured to sense a state associated with each of the plurality of cells, and
circuitry operatively coupled to the sensor system and configured to take an action in response to one or more signals received from the lid sensor, the cell sensors, or both the lid and cell sensors; and
a user device comprising a processor and a display, wherein the processor is configured to communicate with the pillbox and display information about the pillbox via the display.

11. The system of claim 10, wherein the processor is configured to display, via the display, information indicative of medication use by the user and information indicative of one or more health outcomes associated with the user, and wherein the one or more health outcomes comprise an upward or downward trend in average blood pressure.

12. The system of claim 11, wherein the system is operatively coupled to a blood pressure measurement device and configured to receive communication from the blood pressure measurement device regarding blood pressure data of the user, and wherein the blood pressure data is used to determine the upward or downward trend in average blood pressure.

13. The system of claim 10, wherein the processor is configured to determine medication use by the user based on information communicated with the pillbox, thereby monitoring the user's adherence to a medication schedule.

14. The system of claim 13, wherein the processor is configured to determine the user's adherence to the medication schedule and display information about the adherence to the medication schedule via the display.

15. The system of claim 14, wherein the adherence to a medication schedule comprises a consecutive streak of days where the medication was taken.

16. The system of claim 13, wherein the adherence to a medication schedule comprises a percentage of days where the medication was taken over a single time period.

17. The system of claim 13, wherein the adherence to a medication schedule comprises a comparison between the number of pills taken between at least two different time periods.

18. The system of claim 10, wherein the circuitry comprises a Bluetooth low energy transceiver and a wi-fi transceiver, and wherein the circuity is configured to communicate adherence data to the user device via the Bluetooth low energy transceiver when the user device is within a predefined range.

19. The system of claim 18, wherein the circuitry is further configured to communicate adherence data to a remote cloud server via the wi-fi transceiver when the user device is outside the predefined range for at least ten minutes.

20. The system of claim 10, wherein the circuitry is further configured to calculate an adherence metric locally when no network connection is available and to synchronize the metric with the remote server upon re-establishing either Bluetooth Low Energy or Wi-Fi connectivity.

21. A computer-implemented method comprising:
receiving, for each of a plurality of users, blood pressure measurements comprising timestamps and systolic values;
receiving medication adherence signals comprising daily indicators of tracked compliance and consumed compliance;
binning the blood pressure measurements and the medication adherence signals by a common temporal interval to form per-user binned sequences;
joining, per user, the binned blood pressure sequence with the binned adherence sequence by temporal interval to create joint sequences having non-null pairs and nulls otherwise;
filtering the joint sequences to retain users having at least three non-null pairs, a blood-pressure range of at least two units, and an average tracked compliance exceeding 0.3;
computing, for each retained user, a Pearson correlation coefficient between the binned blood pressure sequence and the binned consumed compliance sequence;
labeling a correlation as significant when an absolute value of the coefficient is at least 0.3; and
classifying a trend using last two non-null binned values of each sequence to produce one of: positive-correlation BP-up/medication-up, positive-correlation BP-down/medication-down, negative-correlation BP-up/medication-down, negative-correlation BP-down/medication-up, or a no-correlation class stratified by last blood-pressure bin and last adherence bin.

22. The method of claim 21, wherein the temporal interval is one week and the consumed compliance for a week is an average over daily medication-consumption indicators across all medications.

23. The method of claim 21, further comprising assigning an insight validity period of seven days from creation and a time-to-live of ninety days.

24. The method of claim 21, wherein the blood pressure measurements comprise diastolic values and the method is performed for systolic, diastolic, or both.

25. A computer-implemented method comprising:
identifying a medication-add event for a user from medication records created between one and four months before an analysis time;
selecting the user's blood pressure measurements in a window spanning at least five months and tagging each measurement as before or after the medication-add event when within one month of the event;
computing a before-window median and an after-window median of blood pressure;
determining an effect size by requiring: an absolute difference between the medians of at least 5 mmHg, and at least one of a maximum-before to minimum-after difference or a minimum-before to maximum-after difference of at least 10 mmHg; and
upon satisfying the effect-size requirements, emitting a result comprising the direction of change determined by comparing a most-recent blood pressure to the before-window median.

26. The method of claim 25, further comprising aggregating results across users to compute a count of users with reduced blood pressure after the medication-add event, a mean of per-user median differences, and a percentage relative to all evaluated users.

27. The method of claim 55, wherein the tagging window is configurable and defaults to plus or minus one month.

28. The method of claim 21, further comprising aggregating per-user results into a population-level insight that includes at least one of: a fraction of users satisfying a significance or effect-size criterion, and an average effect magnitude.

29. A system comprising one or more processors and memory storing instructions which, when executed, cause the system to perform the method of claim 21, and further to generate user-interface cards that encode correlation class and trend based on the last two binned points.

30. A non-transitory computer-readable medium storing instructions that, when executed by one or more processors, cause the processors to perform the method of claim 21.
